(19) United States
(12) Patent Application Publication
(10) Pub. No.: US 2010/0017367 A1
(43) Pub. Date: Jan. 21, 2010

(54) Accessing Data Associated with One Application from Another Application

(76) Inventor: Mikko Nurmi, Tampere (FI)

Correspondence Address: HARRINGTON & SMITH, PC, 4 RESEARCH DRIVE, Suite 202, SHELTON, CT, 06484-6212, US

(21) Appl. No.: 12/227,812

(22) PCT Filed: Jun. 21, 2006
(86) PCT No.: PCT/IB2006/003478

§ 371 Date: Apr. 27, 2009

(51) Int. Cl. G06F 17/30; G06F 3/01

(52) U.S. Cl. 707/3; 715/751; 707/E17.014

(57) ABSTRACT

A method involving: automatically identifying a string in a portion of text; extracting, from a calendar application database, data for a portion of the calendar corresponding to the identified string; and enabling display of the extracted calendar data.

### FIELD OF THE INVENTION

Embodiments of the present invention relate to accessing data associated with one application from another application. In particular they relate to accessing calendar data from a non-calendar, text-based application.

### BACKGROUND TO THE INVENTION

It is common for a user when using one application to want access to data available in another application. Typically the user is required to manually activate the another application and navigate to the desired data. They may then need to close the another application to return to the original application.

This is inconvenient. One solution for making this more convenient is the presence of a taskbar at the edge of a computer display screen that has a number of buttons for activating applications.

Although a taskbar may make the activation of applications easier, a user may still have to navigate the application to find the desired data.

### BRIEF DESCRIPTION OF THE INVENTION

It would be desirable to improve the accessibility of data associated with one application from another application.

According to one embodiment of the invention there is provided a method comprising: identifying a string in a portion of text; extracting, from a calendar application database, data for a portion of the calendar corresponding to the identified string; and enabling display of the extracted calendar data.

The identification may be automatic. Automatic is used in this context to mean in response to an event, in this case the display of text, not user input.

According to another embodiment of the invention there is provided a computer program comprising computer program instructions for: identifying a string in a portion of text; extracting, from a calendar application database, data for a portion of the calendar corresponding to the identified string; and enabling display of the extracted calendar data.

According to a further embodiment of the invention there is provided an electronic device comprising: a recognition engine that is arranged to identify a string in a portion of text; an interface for interfacing with a calendar application database to extract data for a portion of the calendar corresponding to the identified string; and a user interface for enabling display of the extracted calendar data.

According to a still further embodiment of the present invention there is provided a method comprising: automatically identifying a string in a portion of text displayed within a first application; extracting, from a database associated with a second different application, data corresponding to the identified string; and enabling display of the extracted data within the first application without activating the second application.

### BRIEF DESCRIPTION OF THE DRAWINGS

For a better understanding of the present invention reference will now be made by way of example only to the accompanying drawings in which:

FIG. 1A is an illustration of the structural components of an electronic device;

FIG. 1B is an illustration of the functional components of the electronic device;

FIG. 2 schematically illustrates a method for presenting calendar application data within another application;

FIG. 3 schematically illustrates an example of one recognition process;

FIGS. 4A and 4B illustrate text, an identified string and extracted calendar data; and

FIGS. 5A, 5B and 5C illustrate text, an identified string, a user-selectable item and extracted calendar data.

### DETAILED DESCRIPTION OF EMBODIMENTS OF THE INVENTION

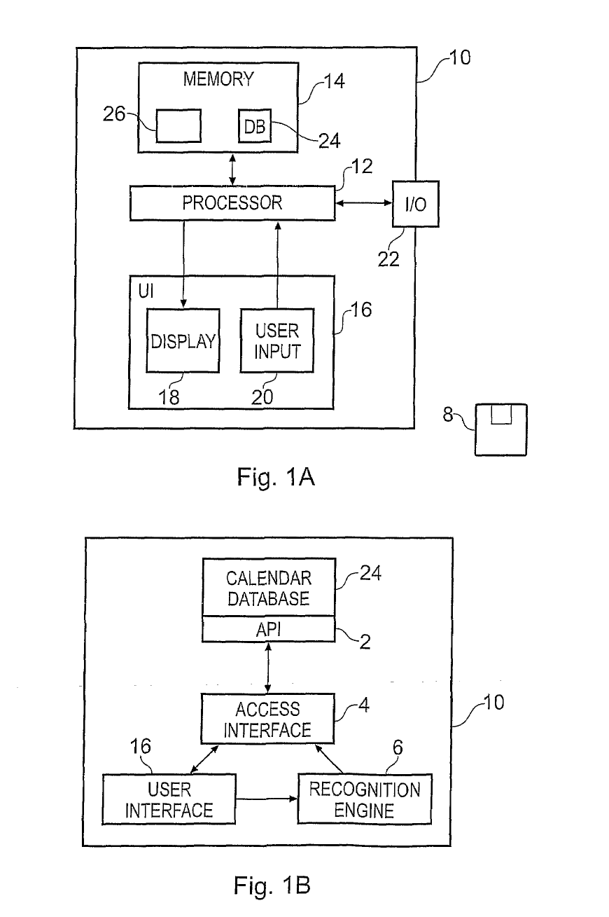

FIG. 1A schematically illustrates an electronic device 10 comprising: a processor 12, a memory 14, a user interface 16 including a display 18 and a user input device 20. Optionally an input/output port 22 for sending and/or receiving data may be present.

Only as many components are illustrated as are referred to in the following description. It should be appreciated that additional or different components may be used in other embodiments of the invention. For example, although a programmable processor 12 is illustrated in FIG. 1 any appropriate controller may be used such as a dedicated processor e.g. an application specific integrated circuit or similar. Any suitable display 18 may be used such as an LCD or CRT. Any suitable user input device 20 may be used including one or more of a keyboard, mouse, keypad, etc

The processor 12 is connected to read from and write to the memory 14, to provide control signals to the display 18, to receive control signals from the user input 20 and to provide data to the port 22 for sending and to receive data from the port 22.

The memory 14 stores computer program instructions 26 and also a calendar database 24. The calendar database is used by a calendar application to provide a calendar in the display 18 when the calendar application is active. The user can create, edit, delete appointments using the user input 20 when the calendar application is active. However, when the calendar application is inactive, the calendar database 24 has been unused until now.

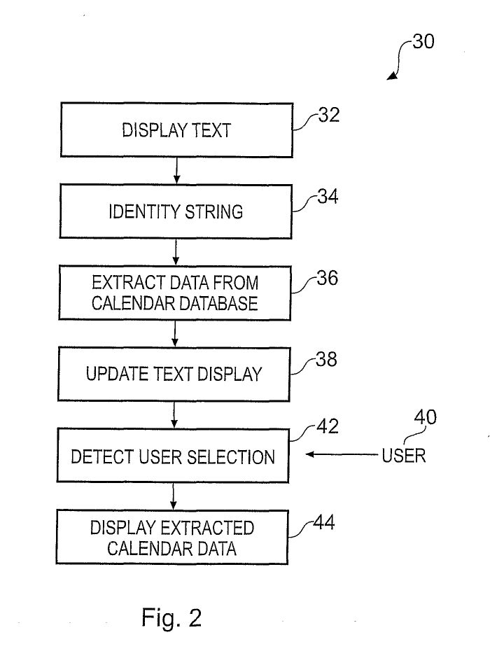

The computer program instructions 26 control the operation of the electronic device 10 when loaded into the processor 12. The computer program instructions 26 provide the logic and routines that enables the electronic device to perform the methods illustrated in FIGS. 2, 3, 4 and 5.

The computer program instructions may arrive at the electronic device 10 via an electromagnetic carrier signal or be copied from a physical entity 8 such as a computer program product, a memory device or a record medium such as a CD-ROM or DVD.

The electronic device 10 may be a personal computer, a personal digital assistant, a mobile cellular telephone, a gaming console, an intelligent refrigerator or any electronic device that provides a database associated with one application that is accessible by another application.

FIG. 1B is an alternative illustration of the electronic device 10. The functional components of the electronic device 10, when a text-based application is active, are illustrated and include the calendar database 24, the user interface 16, and also an access interface 4 and a recognition engine 6.

The calendar database has an API 2 with which the access interface 4 communicates. The user interface 16 has a display for displaying text 3. The recognition engine receives the text 3 as it is displayed and automatically operates on this text to identify within the text 3 a scheduling string 5 that identifies a time period to a user reading the text 3. The time period identified by the recognition engine 6 is then passed to the access interface 4, which uses it to query the database 24 with a request for calendar data including that time period. The calendar data 7 extracted from the database 24 by the query can be passed to the user interface 16 where it is presented on the display 18. The extracted calendar data 7 may, for example, only be passed to the display 18 in response to a user command from the user input device 20.

In some embodiments, the user may be able to use the user input device 20 of the user interface 16 to control the access interface 4 to change the content of the calendar database 24.

The access interface 4 and the recognition engine 6 are provided, in the embodiment of FIG. 1, by the processor 12 when programmed with the computer program 26.

FIG. 2 schematically illustrates a method 30 for presenting calendar application data 7 within another text-based application. Typically, the method can operate within any application that displays text such as a text viewing application, a text composition application, a messaging application etc.

At step 32, text 3 is presented on the display 18. This text 3 may, for example, be text retrieved from the memory 14, text received via the port 22 in a message, or text composed by the user for storage in the memory 14 or sending via the port 22.

The text 3, in this example, comprises a collection of ASCII (American Standard Code for Information Interchange) characters. ASCII characters include alphanumeric characters, punctuation characters and formatting characters. A string is a sequential series of (ASCII) characters.

Next at step 34, a recognition algorithm is automatically run by the recognition engine 6 on the displayed text 3. This algorithm will typically parse the displayed text and identify predetermined strings and convert the string to a scheduling value (if necessary) that identifies without ambiguity a period of time in a calendar. The period of time may be of any duration from minutes to a month.

A predetermined string may, for example, have a predetermined formatting arrangement with variable content or may have a predetermined content. The predetermined arrangements and content are chosen to enable the recognition of scheduling strings i.e. strings that give scheduling information such as a time, date, day, week, month etc.

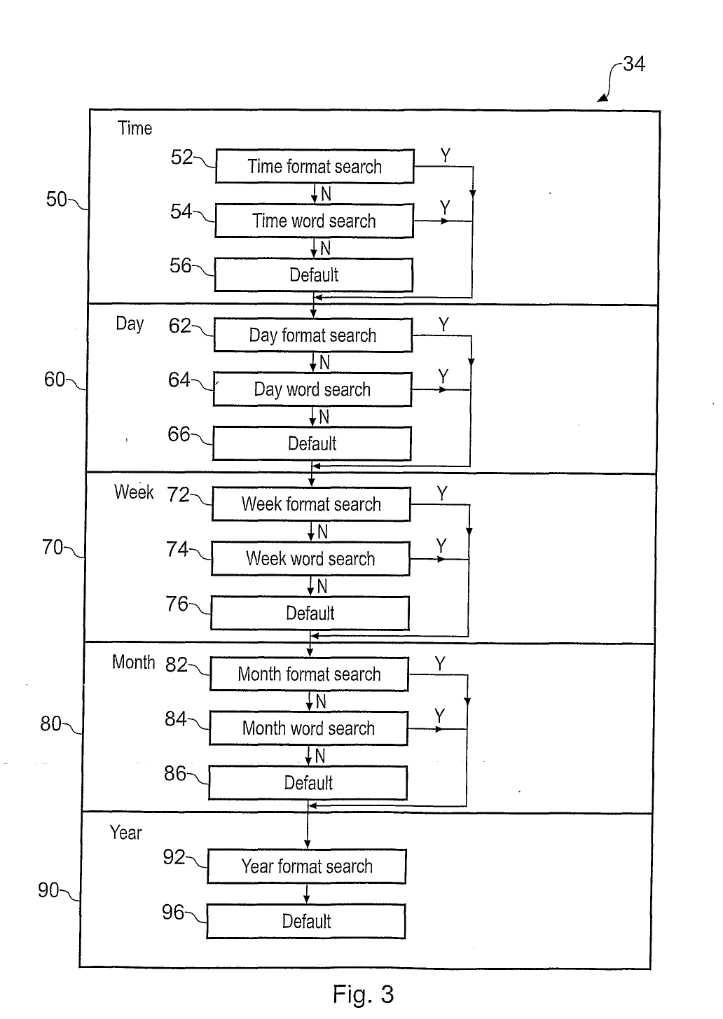

An example of one recognition process is schematically illustrated in FIG. 3 and will be described later.

Next at step 36, the access interface 4 uses the scheduling value determined by the recognition engine 6 to query the calendar database 24. The calendar database 24 responds with calendar data 7 for the time period identified by the scheduling value in the query.

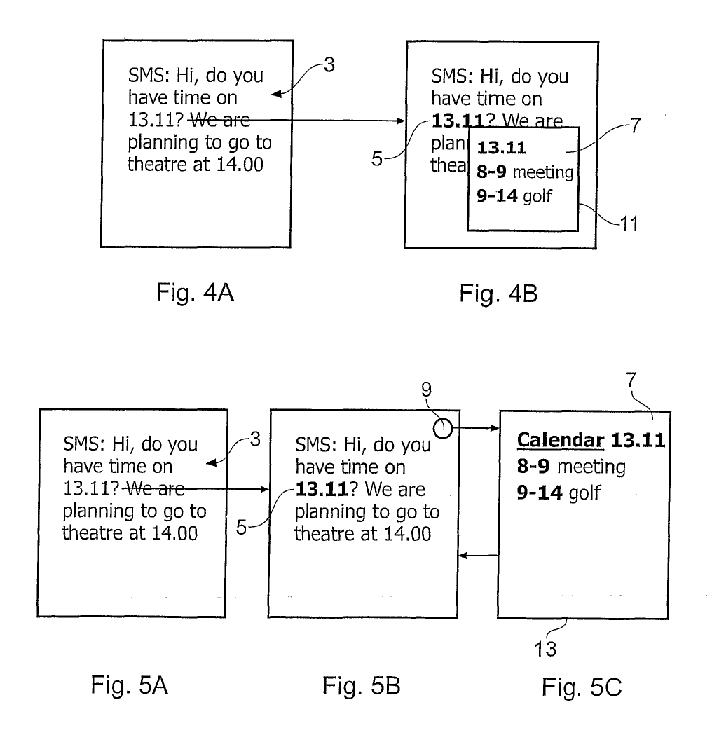

Next at step 38, the text 3 in the display 18 is updated. This is illustrated in FIGS. 4B and 5B.

FIG. 4A illustrates the text 3 before updating and FIG. 4B the text after automatic updating. In FIG. 4B the identified string 5 is automatically highlighted and the extracted calendar data 7 is automatically displayed in the display 18 within a pop-up notification window 11. The pop-up window is typically only temporarily displayed for a few seconds. The user may be able to adjust a user defined setting that determines the period of time the pop-up window is presented before it is removed.

FIG. 5A illustrates the text 3 before updating, FIG. 5B the text after automatic updating but before display of the extracted calendar data 7 and FIG. 5C after display of the extracted calendar data 7. In FIG. 5B the identified string 5 is automatically highlighted and a user selectable item 9 is automatically displayed in the display 18. The user may be able to adjust a user defined setting that determines how long the identified string is highlighted and the user selectable item is available for selection.

Selection of the user-selectable item 9 results in the display of the extracted calendar data 7. Although in this example, the user-selectable item 9 is separated from the identified string 5, in other embodiments the identified string 5 itself operates as the user-selectable item 9. In this case, the user selectable item (the identified string 5) may be selected by moving a cursor on top of the identified string 5 or within a defined area including the identified string 5. The extracted calendar data 7 may then, in this example, be displayed temporarily in a pop-up window. The user may be able to adjust a user defined setting that determines the period of time the pop-up window is presented before it is removed.

The embodiment illustrated in FIG. 2, corresponds to that illustrated in FIGS. 5A, 5B and 5C. A user input 40 is detected at step 42 to select the user selectable item 9.

Next at step 44, the extracted calendar data 7 is displayed to the user, for example, in a pop-up notification window 11 or a screen 13.

It should be appreciated that the display of the extracted calendar data 7 occurs without starting the calendar application.

An additional optional step that may be provided is an ability for the user to add calendar data to the calendar database 24. A user selectable option may be provided that allows a user to allocate the period identified in the text 3 to a user defined subject within the calendar database 24.

FIG. 3 schematically illustrates an example of one recognition process (step 34 in FIG. 2). The user may be able to adapt or edit the recognition process. For example, the user may specify whether a format search and/or a word search is performed for any of time, day, week, month, year. The user may also specify the format or formats used in a format search and may be able to edit the words used in a word search.

At steps 52 to 56 a time period search 50 is performed. The text 3 is searched by the recognition engine 6 to extract a time value.

At step 52, a time format search is performed. This search seeks to find within the text 3 a text string of a predetermined format that represents a time. For example the arrangement <space><numeral><numeral><:><numeral><numeral> is an arrangement indicative of a time. If a time format string is found, it is extracted as a time value and the process moves to step 62, whereas if a time format string is not found the method moves to step 54.

At step 54, a time word search is performed. This search seeks to find within the text 3 a text string of a predetermined content that represents a time. For example the search may look for words ‘midday’, ‘noon’, ‘afternoon’, ‘morning’, ‘evening’, ‘lunch’, ‘am’, ‘pm’ etc that indicate times or time periods. If a time word string is found, it is extracted, converted to an explicit time value and the process moves to step 58, whereas if a time word string is not found the method moves to step 56.

At step 56, the default time is set. In this example it is 12:00. Then the method moves to step 62.

At steps 62 to 66 a ‘day’ search 60 is performed. The text 3 is searched to extract at least a day value.

At step 62, a date format search is performed. This search seeks to find within the text 3 a text string of a predetermined format that represents a date. For example the arrangement <space><numeral><numeral><: or / or . or -><numeral> <numeral><: or / or . or -><numeral><numeral> is an arrangement indicative of a date.

If a date format string is found, it is extracted as a day value, a month value and a year value and the process ends, whereas if a date format string is not found the method moves to step 64.

At step 64, a day word search is performed. This search seeks to find within the text 3 a text string of a predetermined content that represents a day. For example the search may look for words ‘tomorrow’, ‘day after tomorrow’, ‘Christmas Day’, or any of the names of the days of the week, etc. If a day word string is found, it is extracted and converted to an explicit day value and the process moves to step 72, whereas if a day word string is not found the method moves to step 66.

At step 66, if a non-default time value has already been determined, the day value is set to a default value-today. Then the method moves to step 72.

At steps 72 to 76 a ‘week’ search 70 is performed, except if both a day value and a month value are already specified. The text is searched to extract a week value.

At step 72, a week format search is performed. This search seeks to find within the text 3 a text string of a predetermined format that represents a week. For example the arrangement <space>‘week’ <space><number> is an arrangement indicative of a week number.

If a week format string is found, it is extracted as a week value and the process moves to step 82, whereas if a week format string is not found the method moves to step 74.

At step 74, a week word search is performed. This search seeks to find within the text 3 a text string of a predetermined content that represents a week. For example the search may look for words ‘this week’, ‘next week’, ‘fortnight’, ‘week after next’ etc. If a week word string is found, it is extracted converted to an explicit week value and the process moves to step 82, whereas if a week word string is not found the method moves to step 76.

At step 76, the default week value is set to this week if a day value but not a month value has been determined already. Then the method moves to step 82.

At steps 82 to 86 a ‘month’ search 80 is performed, except if a month value or week value have already been determined. The text is searched to extract a month value.

At step 82, a month format search is performed. This search seeks to find within the text 3 a text string of a predetermined format that represents a month. For example the arrangement <space>‘month’<space><number> is an arrangement indicative of a month number.

If a month format string is found, it is extracted as a month value and the process moves to step 92, whereas if a month format string is not found the method moves to step 84.

At step 84, a month word search is performed. This search seeks to find within the text 3 a text string of a predetermined content that represents a month. For example the search may look for words ‘this month’, ‘next month’, ‘month after next’ or any of the month names etc. If a month word string is found, it is extracted converted to an explicit month value and the process moves to step 92, whereas if a month word string is not found the method moves to step 86.

At step 86, the default month value is set to this month. Then the method moves to step 82.

At steps 92 and 96 a ‘year’ search 90 is performed, except if the year value is already specified. The text is searched to extract a year value.

At step 92, a year format search is performed. This search seeks to find within the text 3 a text string of a predetermined format that represents a year. For example the arrangement <space><20><numeral><numeral> is an arrangement indicative of a calendar year.

If a year format string is found, it is extracted as a year value and the process ends, whereas if a year format string is not found the method moves to step 86

At step 86, the default year value is set to this year. Then the process ends.

The scheduling values (time, day, week, month, year) specified at the end of the process are used as a combination by the access interface 4 to query the calendar database.

In this example, the minimum scheduling value a query will have are a year value and a month value. The scheduling value will unambiguously define a month, a week, a day or a period of time.

If the lowest value in the scheduling value is a month value, then the database 24 responds to such a query by providing data for reproducing the calendar entries for that month. The extracted calendar data 7 may be presented as a ‘month view’.

If the lowest value in the scheduling value is a week value, then the database 24 responds to such a query by providing data for reproducing the calendar entries for that week. The extracted calendar data 7 may be presented as a ‘week view’.

If the lowest value in the scheduling value is a day value, then the database 24 responds to such a query by providing data for reproducing the calendar entries for that day. The extracted calendar data 7 may be presented as a ‘day view’.

If the lowest value in the scheduling value is a time value, then the database 24 responds to such a query by providing data for reproducing the calendar entries for the period of time including that time value. The extracted calendar data 7 may be presented as a ‘part-of-day view’.

Although embodiments of the present invention have been described in the preceding paragraphs with reference to various examples, it should be appreciated that modifications to the examples given can be made without departing from the scope of the invention as claimed. For example, the identified string could be a name, address or other personal identifier and the extracted data for display within the text-based application could be extracted from a contacts database associated with another, different application.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. A method comprising:
identifying a string in a portion of text;
extracting, from a calendar application database, data for a portion of the calendar corresponding to the identified string; and
enabling display of the extracted calendar data.

2. A method as claimed in claim 1, further comprising enabling the automatic identification of a string in a portion of text when a first application, other than the calendar application, is in use.

3. A method as claimed in claim 2, wherein the first application is an application that displays text.

4. A method as claimed in claim 2, wherein the first application is an application that enables text composition.

5. A method as claimed in claim 2, wherein the first application is a messaging application.

6. A method as claimed in claim 1, wherein the automatically identifying a string in a portion of text is automatically carried out in any one of a plurality of first applications.

7. A method as claimed in claim 1, wherein the string identifies a time.

8. A method as claimed in claim 1, wherein the string identifies a date.

9. A method as claimed in claim 1, wherein the string is identified because it corresponds to a predetermined format or formats.

10. A method as claimed in claim 1, wherein the string is identified because it corresponds to a predetermined content.

11. A method as claimed in claim 1, wherein display of the extracted calendar data occurs without starting the calendar application.

12. A method as claimed in claim 1, wherein the portion of the calendar that is extracted and displayed depends upon the identified string.

13. A method as claimed in claim 12, wherein the portion relates one or more of: a portion of a day, a day view, a week view or a month view.

14. A method as claimed in claim 1, wherein a part of the displayed extracted calendar data is highlighted, the part depending upon the identified string.

15. A method as claimed in claim 1, wherein a user selectable option to display the extracted calendar data is provided.

16. A method as claimed in claim 15, wherein the text is displayed and the user selectable option is associated with the identified string in the displayed text.

17. A method as claimed in claim 1, wherein the extracted calendar data is displayed in a pop-up notification window.

18. A method as claimed in claim 1, wherein when the extracted calendar data is displayed, a user selectable option is provided adapt to the calendar application database corresponding to the portion of the calendar displayed.

19. A computer readable product comprising computer program instructions which when loaded in a processor enable:
identifying a string in a portion of text;
extracting, from a calendar application database, data for a portion of the calendar corresponding to the identified string; and
enabling display of the extracted calendar data.

20. A computer readable product as claimed in claim 19, wherein automatically identifying a string in a portion of text is automatically carried out in any one of a plurality of first applications.

21. An electronic device comprising:
a recognition engine that is arranged to identify a string in a portion of text;
an interface for interfacing with a calendar application database to extract data for a portion of the calendar corresponding to the identified string; and
a user interface for enabling display of the extracted calendar data.

22. A method comprising:
automatically identifying a string in a portion of text displayed within a first application;
extracting, from a database associated with a second different application, data corresponding to the identified string; and
enabling display of the extracted data within the first application without activating the second application.

23. An apparatus as claimed in claim 21, wherein the recognition engine is configured to automatically identify a string in a portion of text in one or more first applications.

24. An apparatus as claimed in claim 23, wherein the first application is a messaging application.

25. An apparatus as claimed in claim 21, wherein the recognition engine is configured to identify the string because it corresponds to a predetermined format, formats or content.

26. An apparatus as claimed in claim 21, wherein display of the extracted calendar data occurs without starting a calendar application.

27. An apparatus as claimed in claim 21, wherein the extracted calendar data is displayed in a pop-up notification window.

28. An apparatus as claimed in claim 21, wherein when the extracted calendar data is displayed, a user selectable option is provided adapt to the calendar application database corresponding to the portion of the calendar displayed.
